(19) United States
(12) Patent Application Publication
(10) Pub. No.: US 2002/0065744 A1
(43) Pub. Date: May 30, 2002

(54) Method for internet matching of user request to specific merchandise

(76) Inventor: Seth Collins, New York, NY (US)

Correspondence Address: Keith D. Nowak, Lieberman & Nowak, LLP, 350 Fifth Avenue, New York, NY, 10118, US

(21) Appl. No.: 09/726,503

(22) Filed: Nov. 30, 2000

Related U.S. Application Data
(60) Provisional application No. 60/168,101, filed on Nov. 30, 1999.

(51) Int. Cl. G06F 17/60

(52) U.S. Cl. 705/27

(57) ABSTRACT

A method for Internet matching of user requests to merchandise meeting his requirements, in particular the sale of refurbished and special deal items along with factory-new items.

### FIELD OF THE INVENTION

This invention generally relates to the computerized on-line retail of consumer merchandise, in particular the sale of refurbished and special deal items along with factory-new items.

### BACKGROUND OF THE INVENTION

With the growth of the Internet in recent years there has been an explosion in electronic commerce, or “e-commerce”, as traditional “brick and mortar” retail stores and Internet startups hawk their wares on the Internet. On-line websites offering sales of consumer products have become commonplace and has changed the way consumers shop. Studies show on-line purchases of consumer goods to continue to grow, with sales reaching $6.373 billion in the third quarter, 2000. However, even with this explosive growth, online sales accounted for less than 1 percent of total retail sales., and fierce competition amongst on-line retailers have led to many companies ceasing operations.

In this competitive environment, many companies realized that they needed to enhance their e-commerce presence. At the same time, companies want to find a way to take advantage of their ability to purchase “Special Deals.” Special Deals can be defined as closeout products or refurbished products. Closeouts are normally end of life inventories purchased from manufacturers or are from cash starved companies which sell inventories at cents to the dollar. Refurbished products are usually products that, for one reason or another, have been sold once and returned to the manufacturer where they are refurbished and repackaged to be in re-sellable condition.

These retail products (either sold online or at brick and mortar stores) can be grouped into three categories:

A-goods—Brand new, right off the manufacturer's assembly line, goods. A-goods are what most people are familiar with and historically have purchased.

R-goods—Manufactured refurbished goods. Products which customers have returned whether they actually used them or not. By law, manufacturers, or manufacturer's service center, must inspect, test and QA the products before they are resold and these can not be represented as new.

Special Deals—Either end of life A-goods or over stocked or A-good inventories that cash starved retailers sell in bulk at a substantial discount.

While the sale of refurbished products and Special deals have gained a level of acceptance on the Internet, especially with auction websites such as www.eBay.com, consumers still tend to look at these goods as being second-rate to premium factory-new items. Perhaps mirroring their shopping habits in the brick and mortar world, on-line consumers would often overlook bargain items and may view them as being less reliable, especially since they cannot inspect the condition of these items before the sale. Frequently on-line shoppers shopping for items would by-pass refurbished items or Special deals unless they were specifically looking for bargains. As a result, websites (or different sections of a website) are usually set up as selling A-goods only, or set up as selling R-goods and Special Deals only, limiting a consumer's choices.

It is therefore an object of the present invention to provide on-line shoppers with an unique shopping experience which, through a sophisticated evaluation of their purchase criteria, entices them to consider the purchase of R-goods and Special Deals while offering A-goods for purchase in the same transaction.

### SUMMARY OF THE INVENTION

To address the shortcomings of present methods of selling R-goods and Special Deal items, the present invention is a novel method of on-line retailing with rules associated with the making of recommendations for purchase and the way choices are presented to the customers. The invention allows the customer to make an educated choice when purchasing goods.

The invention presents customers choices to maximize savings, either through price or through value (or both). This is done via an automatic behind the scenes program that searches the entire inventory database (all three categories), selects and displays the recommended products along with the webpage(s) depicting the requested product. This automatic program is novel in that it selects the recommended products result set by using the parameters (category, price, product attributes, warranty) of the product the customer clicked on to request additional information. The result set does not have to be from the same manufacturer. The automatic program is referred to as the “Differentiator Engine.” The Differentiator Engine is actually the group of programs which stores and executes the rules/automatic routine, and selects, maintains and communicates the result set back to the customer via the Web.

The price savings occurs when the customer is offered the identical product in addition to a similar product for significantly less money than the product they requested. The resulting set includes either R-good, Special Deal, and/or another A-good product. The value savings occurs when the customer is offered a product of better quality or more features for the same selling price as the product they initially requested.

An example:

When a customer clicks on a specific A-good product, for example a 19″ TV from Brand “A” with a selling price of $400, they are requesting additional information on that particular product, and defining the parameters they are interested in. Based on those parameters, the invention will automatically display the requested A-good 19″ TV from Brand “A”, and:

A R-good Brand “B” 19″ TV selling at $300—Price Savings

An A-good Brand “C” 19″ TV selling $369—Price Savings

A R-good Brand “D” 27″ TV selling at $400—Value Savings

In the above example, the customer initially selected an A-good product to view additional information on, and is then presented with more targeted choices than he would ordinary find if he was browsing on his own. (The Differentiator Engine performs the same functions, if the customer initially selects an R-good or Special Deal product.) The idea is to present the customer with a truly objective way to view product choices based on what they are interested in, and then to enable them to make a fully educated purchase decision.

When a customer clicks on a specific product, they are automatically defining what product they are interested in and what price range they are willing to spend. These parameters may include:

1. Category

2. Price

3. Product Features/Specifications

4. Warranty

The Differentiator Engine uses these parameters and utilizes a decision matrix to select the products that will be recommended to the customer. The decision matrix will select products that are:

Within the same basic category structure. For example, if the customer selected a 19″ TV a DVD player will not be included in the result set;

Price savings—the product selected is either exact or most similar to requested product and provides the customer with the greatest savings potential;

Value savings—the product selected has the same basic features as the product requested, plus has the most added features/better specifications with a selling price not to exceed a percentage (e.g. 5%) more than the selling price of the requested product;

Product features—a feature is grouped into two categories: Inherent or optional. To be considered like or similar to a requested product, the resulting product must have all the inherent features and a major portion (e.g. 75%) of the optional attributes; and

All resulting products must have comparable manufacturer's warranty.

### BRIEF DESCRIPTION OF DRAWINGS

FIG. 1 is a schematic showing the technical architecture overview of the system.

FIG. 2 is a flowchart showing the process of a customer requesting information on a specific product.

FIG. 3 is a flowchart showing the customer requesting more products from the result set.

### DESCRIPTION OF PREFERRED EMBODIMENT

The preferred embodiment of the invention consists of a two-part process: The first process occurs when the customer requests additional information on a specific product. The result is a web page with the requested product and its additional information, along with “first choice” products determined by the Engine. The second process occurs when the customer wants to see additional products from the result set. The customer clicks on the “Additional Choices” button which allows them to view more products chosen by the Engine. These chosen products are the remaining products of the result set, which were not displayed in process one.

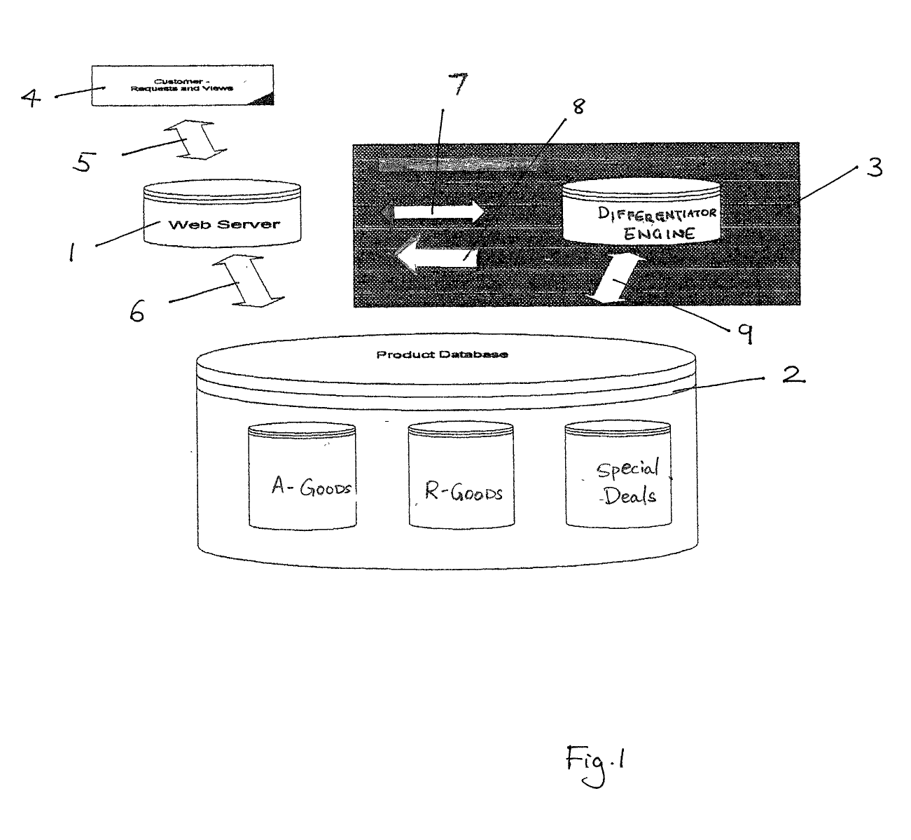

In the embodiment as depicted in FIG. 1, a web server 1 is used as the conduit between the Product database 2, Differentiator Engine 3 and the customer. When a customer selects a navigation option (i.e., requests product information, chooses a purchase, performs a search) on a web page 4, an unique request id is generated 5. The web server would use the request id to query the database 6 in order to build a result set of the customer's requested products.

Additionally, the invention will make use of a novel interface in which the web server would communicate with the Differentiator Engine first 7, and only after the Differentiator Engine generates a result set of recommended products 8, will the server query the database 6 for the requested detail information and the result set detail information. The result set of recommended products will be integrated with the customer's requested products in populating and building the resulting web page. The Differentiator Engine is also in communication with the Product Database 9 so that it always makes choices based on the availability of the items in the database.

The Differentiator Engine is uniquely designed as an interface between the web server and the database. It is a set of rule-based executables used to query the database in order to select, define, store the product ids of the result set, both “first choice” and “additional choices” products. It communicates the result set product ids to the web server, so the server can fetch the appropriate product's detail information.

The database stores all product information, and can also act as the inventory control. It consists of databases for each product type, including product information, specifications, and photographs of the product. Product types include A-goods, R-goods, and Special Deals.

The Differentiator Engine is triggered when a customer selects a product they would like to receive additional information about. The uniqueness of the Differentiator Engine is the ability to provide customers with an automated service driven by their interests, not from the store's non-targeted recommendations or other customer's interests.

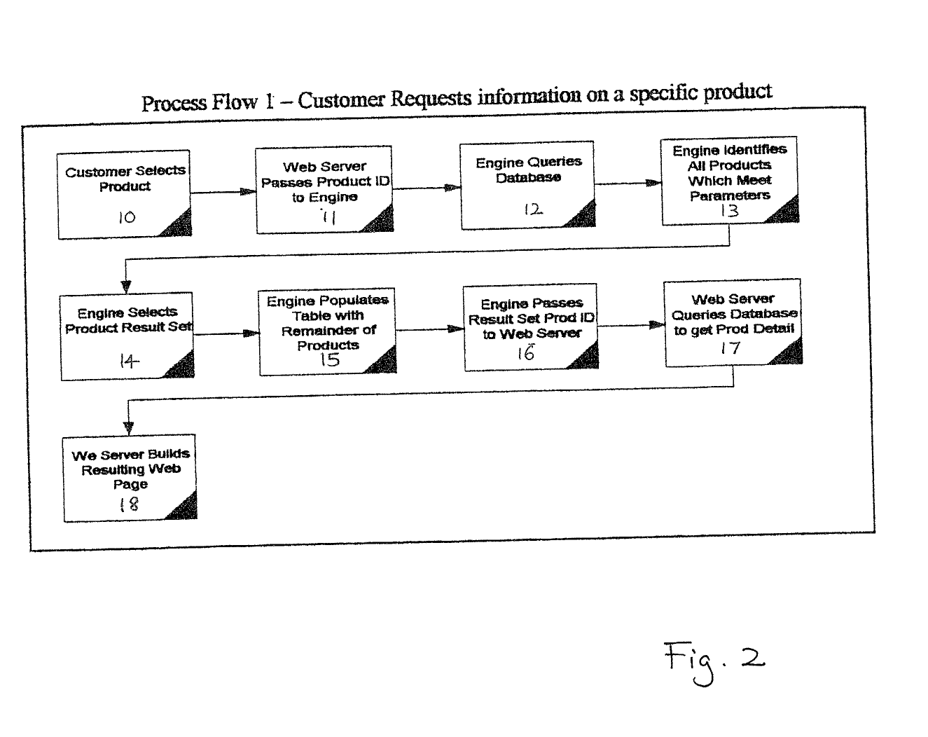

Referring to the process flowchart depicted in FIG. 2, a customer selects a product from the on-line website and triggers the Differentiator Engine 10. This occurs when the customer selects a product, from anywhere on the site, to view additional information about that product. The Differentiator Engine automatically uses the selected product's parameters (category, price, attributes and warranty) as search criteria when it queries the database, and parameters for populating the product result set. The Web Server then passes the customer-selected product ID and its parameters to the Differentiator Engine 11. The Engine, using the search criteria defined in step 10, queries the database to identify all products which satisfy its search criteria and Price and Value saving rules 12. The Differentiator Engine, using its rules-based decision matrix, identifies products which meet the subject parameters 13. These “choice” products are the total subset of products within the database which meet the search criteria and Price and Value savings rules. The result set products are then categorized into Price and Value saving groups. The Engine then selects a single product per group from the result set 14. This “first choice” product is the product which will be returned to the web server to be displayed on the web page returned to the customer along with the requested product. This “first choice” product is the product which offers the customer the biggest savings opportunity for the exact or the most similar product or the most value for the customer's dollar. The Engine then populates a temporary table 15 per group with the remaining result set products, or “additional choice” products, which are not returned to the web server to be displayed to the customer in process 10. The Engine next passes the web server the product ID of the “first choice” product for each group 16, and the Web Server queries the database to extract product detail for the customer-requested product as well as the “first choice” result set products 17. The Web Server then builds the resulting Web Page with the requested product and the “first choice” recommended products and displays the page to the customer 18.

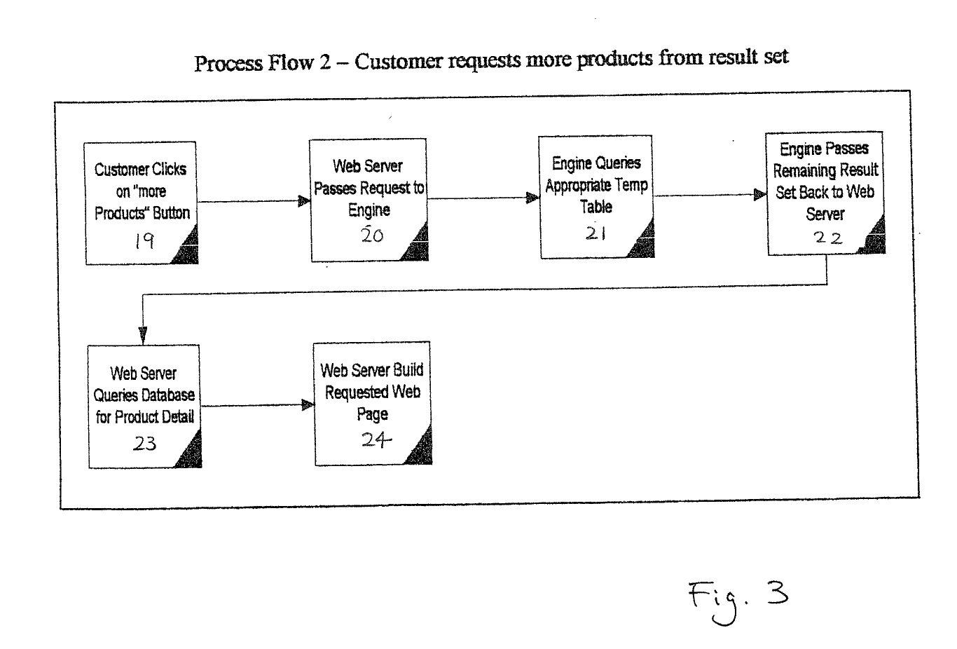

Referring to the process flow chart depicted in FIG. 3, the Differentiator Engine continues through the first resulting web page when a customer requests to see additional products from the result set. The additional products can be included in the Price savings result set or the Value savings result set. The customer clicks on the appropriate button (either for Price or Value savings) to review “additional choices” products 19. At this point the customer wants to see additional savings opportunities which was determined by the Differentiator Engine to fit their shopping needs. The web server passes the customer request to the Engine 20 in order to retrieve the newly requested Product Ids defined in the initial process one search. Based on the second request, the Engine uses the parameters passed to it by the web server (Price or Value saving “additional choice” products) to query the appropriate temporary table (built in step 15) 21. The Engine then passes the remaining Results Set Product Ids of the “additional choices” products to the Web Server 22, and the Web Server queries the database to extract product detail 23 for the product the customer originally requested as well as the “first choice” result set products. Finally, the Web Server builds the requested web page and displays the page to the customer 18. The customer is still shown the original product requested along with a listing of the “first choice” and “additional choices” products. This listing is the entire result set for the requested group (Price or Value).

Although the present invention and its advantages have been described in the foregoing detailed description and illustrated in the accompanying drawings, it will be understood by those skilled in the art that the invention is not limited to the embodiment(s) disclosed but is capable of numerous rearrangements, substitutions and modifications without departing from the spirit and scope of the invention as defined by the appended claims.

What is claimed is:

1. A method for the on-line retail of factory-new, refurbished and special deal goods, comprising the steps of:
a customer selecting a product from an on-line catalog;
a web server generating an unique product ID from the customer's selection of product and passing the product ID to a software differentiator engine;
the differentiator engine setting up a rules-based search criteria defined by the customer's selection of product, and searching an on-line database to produce a first search result of products which satisfy the search criteria;
the differentiator engine categorizing the first search result into price and value saving groups;
the differentiator engine selecting a single product from each saving group and returning these products to the web server;
the web server generating a web page showing the customer's selected product and the products selected by the differentiator engine.

2. The method of claim 1, further comprising the steps of:
the differentiator engine creating temporary tables for the price and value saving groups with the remaining products not returned to the web server.

3. The method of claim 2, further comprising the steps of:
the customer requesting the web server to see additional products from the first search result;
the web server passing the customer request to the differentiator engine;
the differentiator engine searching the temporary tables and generating a second search result of additional choices;
the differentiator engine passing the second search result of additional choices to the web server;
the web server queries the database to extract product detail for the product the customer originally selected as well as the products from the search results;
the web server building the requested web page showing the product the customer originally selected as well as the products from the search results, and displaying the page to the customer.
